(19) United States
(12) Patent Application Publication
(10) Pub. No.: US 2016/0160073 A1
(43) Pub. Date: Jun. 9, 2016

(54) Methods and Compositions for Material Extrusion 3D Printing

(71) Applicant: Board of Regents, The University of Texas System, Austin, TX (US)

(72) Inventors: David A. Roberson, El Paso, TX (US); Angel R. Torrado Perez, Lakewood, CO (US); Carmen R. Rocha, El Paso, TX (US)

(73) Assignee: Board of Regents, The University of Texas System, Austin, TX (US)

(21) Appl. No.: 14/960,247

(22) Filed: Dec. 4, 2015

Related U.S. Application Data
(60) Provisional application No. 62/087,645, filed on Dec. 4, 2014.

(51) Int. Cl. C09D 155/02; C09D 153/02

(52) U.S. Cl. CPC C09D 155/02; C09D 153/02; B33Y 70/00

(57) ABSTRACT

Methods and compositions directed to blends of acrylonitrile butadiene styrene (ABS) with styrene ethylene butadiene styrene (SEBS) are disclosed. In certain aspects, the blends further include an ultrahigh molecular weight polyethylene (UHMWPE). In a further aspect, the blends are compatible with 3D printing platforms.

### CROSS-REFERENCE TO RELATED APPLICATIONS

This application claims the benefit of the filing date of U.S. Provisional Patent Application Ser. No. 62/087,645, filed on Dec. 4, 2014, by the inventors of this application, and incorporated herein by reference.

### STATEMENT REGARDING FEDERALLY SPONSORED RESEARCH

Not applicable.

### TECHNICAL FIELD OF THE INVENTION

The present disclosure relates generally to methods and compositions for material extrusion 3D printing (ME3DP). More particularly, the disclosure relates to methods and compositions for use of thermoplastic rubber (TPR) such as styrene ethylene butadiene styrene (SEBS) in an optimized ratio to generate toughened, rubberized acrylonitrile butadiene styrene (ABS) blends which are compatible with ME3DP platforms.

### BACKGROUND

Material extrusion 3D printing (ME3DP) based on fused deposition modeling (FDM) technology is currently the most commonly used additive manufacturing method. In this 3DP process, a thermoplastic polymeric filament is deposited in a manner analogous to a glue gun in a layer-by-layer nature until a 3D object is created. However, ME3DP suffers from a limitation of compatible materials and typically relies upon amorphous thermoplastics, such as ABS.

A strategy to increase the number of materials available for material extrusion 3D printing is the blending of printable materials with other polymers in an effort to create materials which have different physical properties, yet maintain compatibility with existing material extrusion 3D printing platforms. There is a need for additional materials for use in existing 3D printing platforms.

### SUMMARY

In view of the aforementioned problems and trends, general embodiments of the present disclosure provide methods and compositions for ME3DP using blends of styrene ethylene butadiene styrene (SEBS) and acrylonitrile butadiene styrene (ABS).

In one aspect of the disclosure, a polymer blend composition may have a ratio of ABS:SEBS between about 80:20 and about 50:50 by weight.

In another aspect of the disclosure, the composition is configured as a printable monofilament.

Yet another aspect of the disclosure teaches a composition that is a blend of acrylonitrile butadiene styrene (ABS), styrene ethylene butadiene styrene (SEBS), and ultrahigh molecular weight polyethylene (UHMWPE).

Specifically, in one other aspect, the blend comprises a ratio of ABS:UHMWPE:SEBS between 75:25:10 and 90:10:10 by mass.

Furthermore, the present disclosure teaches a method of blending acrylonitrile butadiene styrene with ultrahigh molecular weight polyethylene which involves the blending of acrylonitrile butadiene styrene with styrene ethylene butadiene styrene; and then adding ultrahigh molecular weight polyethylene to this blend.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present claimed subject matter, and should not be used to limit or define the present claimed subject matter. The present claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 is a black and white schematic illustrating a multi-material object created with the blend(s) [gray region between the white/ABS material] described herein in conjunction with ABS (white square material),

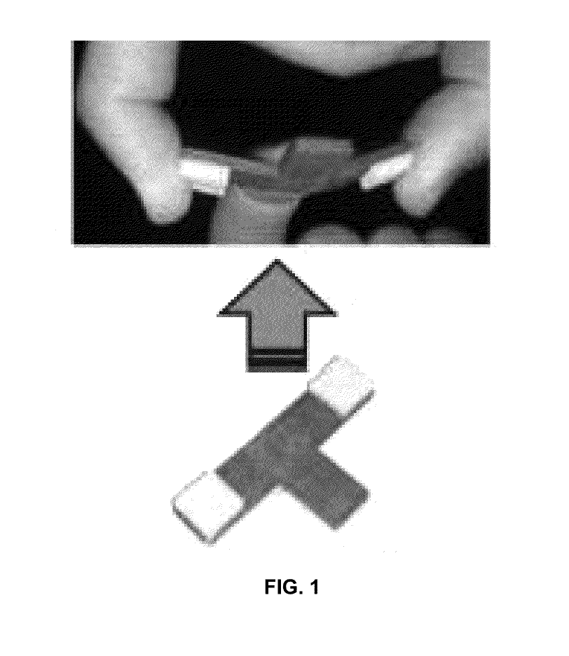

FIG. 2A is a graph of the tensile test data (stress versus axial strain) depicting the effect of the addition of increasing percentages of SEBS (TP RUBBER) to ABS while FIG. 2B is a schematic of the resulting flexible blend material using an optimized ratio of a 50/50 by weight percent blend of ABS/SEBS after 3D printing,

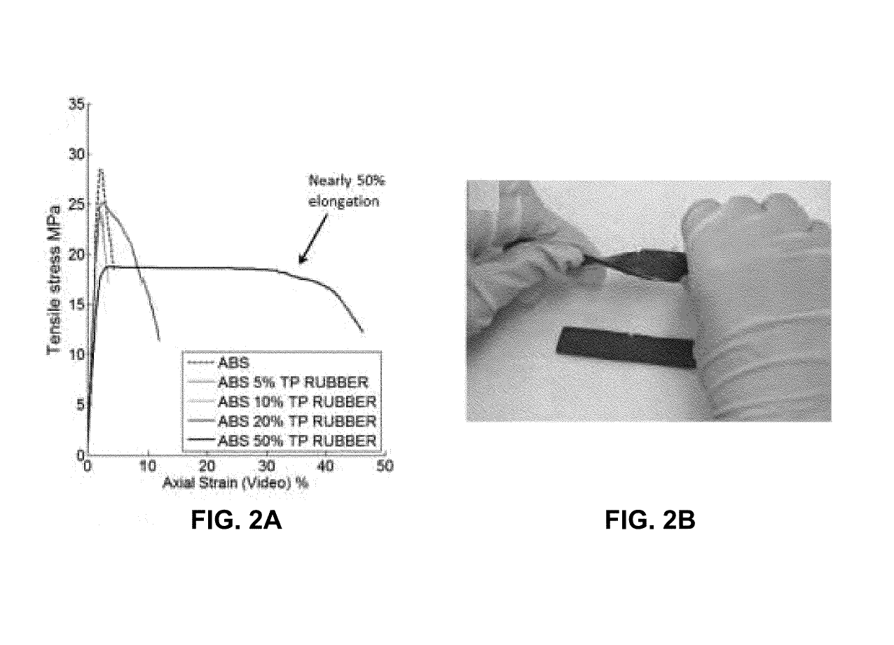

FIG. 3 is a composite of black and white scanning electron microscope (SEM) photographs depicting the rheological differences between an ABS and an ABS:SEBS blend disclosed herein,

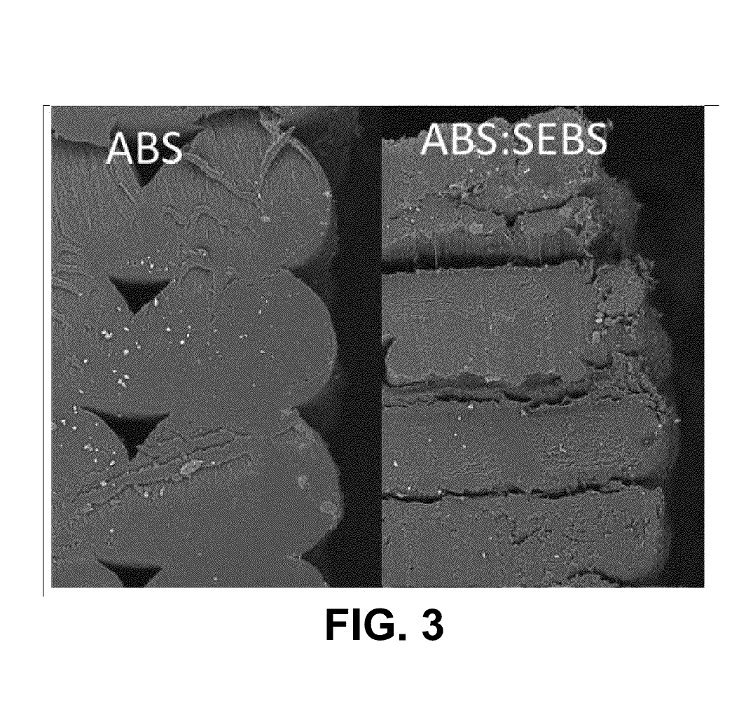

FIGS. 4A and 4B are black and white SEM photographs of the (a) SEBS and (b) UHMWPE polymer before compounding. The size distribution of the UHMWPE polymer is depicted in the graph in FIG. 4C,

FIG. 5A is illustrates a schematic diagram of a Type V tensile test specimen where the raster direction is designated by arrows and hash marks. The structure depicted in FIG. 5B was designed to test surface roughness with surface angles at 10°, 20°, 30°, and 45° with respect to the surface normal,

FIG. 6 is a composite of stress—strain diagrams generated from tensile test data for all material systems tested herein,

FIGS. 7A-7D depicts micrographs of various ABS:SEBS blends wherein the proportion of ABS:SEBS are 95:5 in FIG. 7A, 90:10 in FIG. 7B, 80:20 in FIG. (C, and 50:50 in FIG. 7D,

FIGS. 8A-8C are a composite of black and white SEM micrographs comparing ABS only in FIG. 8(A), to a 50:50 ABS:SEBS blend in FIG. 8B, and to a 75:25:10 ABS:UHMWPE:SEBS ternary blend in FIG. 8C,

FIGS. 9A-9D are a composite of black and white SEM micrographs comparing various blends of ABS:UHMWPE:SEBS. FIGS. 9A and 9B are 90:10:10 blends of ABS:UHMWPE:SEBS, wherein FIG. 9B is a more magnified view of FIG. 9A and FIGS. 9C and 9D are 75:25:10 blends of ABS:UHMWPE:SEBS, wherein FIG. 9D is a more magnified view of FIG. 9C,

FIG. 10 is an SEM micrograph depicting the representative fracture surface of a tensile specimen printed from ABS,

FIG. 11A and 11C are a composite of black and white SEM micrographs comparing ABS only in FIG. 11A and a 75:25:10 ABS:UHMWPE:SEBS ternary blend in FIG. 11C, while FIG. 11B is a graphical representation of the ultimate tensile strength (UTS) of the ABS and the ABS:UHMWPE:SEBS 75:25:10 ternary blend of FIG. 11A and FIG. 11C, and

FIGS. 12A-12C depict SEM images of cross sections of ABS only in FIG. 12A, a ABS:SEBS 50:50 blend in FIG. 12B and a ABS:UHMWPE:SEBS 75:25:10 blend in FIG. 12C while FIG. 12D illustrates the corresponding surface roughness data of FIGS. 12A-12C.

### NOTATION AND NOMENCLATURE

Certain terms are used throughout the following description and claims to refer to particular system components and configurations. As one skilled in the art will appreciate, the same component may be referred to by different names. This document does not intend to distinguish between components that differ in name but not function.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. Thus, they should be interpreted to mean “including, but not limited to . . . .”

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. The same or similar parts may be marked with the same or similar reference numerals.

While various embodiments are described herein, it should be appreciated that the present invention encompasses many inventive concepts that may be embodied in a wide variety of contexts. The following detailed description of exemplary embodiments, read in conjunction with the accompanying drawings, is merely illustrative and is not to be taken as limiting the scope of the invention, as it would be impossible or impractical to include all of the possible embodiments and contexts of the invention in this disclosure. Upon reading this disclosure, many alternative embodiments of the present invention will be apparent to persons of ordinary skill in the art. The scope of the invention is defined by the appended claims and equivalents thereof.

Illustrative embodiments of the invention are described below. In the interest of clarity, not all features of an actual implementation are described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

Material extrusion 3D printing (ME3DP) is a technology that relies upon the extrusion of a thermoplastic monofilament through a heated nozzle. Originally trademarked as fused deposition modeling (FDM™), there has been a dramatic increase in the use of this technology with rapid growth in the form of desktop models of various grades and do-it-yourself (DIY) kits due to the expiration of the original patents on the technology in 2009. As is the case with other 3D printing technologies, ME3DP presents many advantages over traditional manufacturing techniques, most notably direct computer aided design (CAD) to final part fabrication, the capability to print unique and complex geometries, and short design to product cycle time. The flexibility of ME3DP makes it an attractive manufacturing platform; however, the greatest limitation to this technology is a dependence on amorphous polymeric materials as a feedstock, limiting the amount of printable materials. The lack of a large variety of compatible materials limits the applicability of parts fabricated.

A strategy to increase the number of materials available to material extrusion 3D printing is the blending of printable materials with other polymers in an effort to create materials which have different physical properties, yet maintain compatibility with existing material extrusion 3D printing platforms.

This disclosure teaches a blended ABS with styrene ethylene butadiene styrene (SEBS) also known as thermoplastic rubber (TPR) which creates a rubberized (flexible), yet 3D printable material which can be used in commercially available 3D printers. Furthermore, the blend(s) described herein, in conjunction with ABS, have expanded the ability to create multi-material objects using such printers. While the disclosure herein uses SEBS in the examples, other TPR with similar properties may be used and are contemplated by this disclosure.

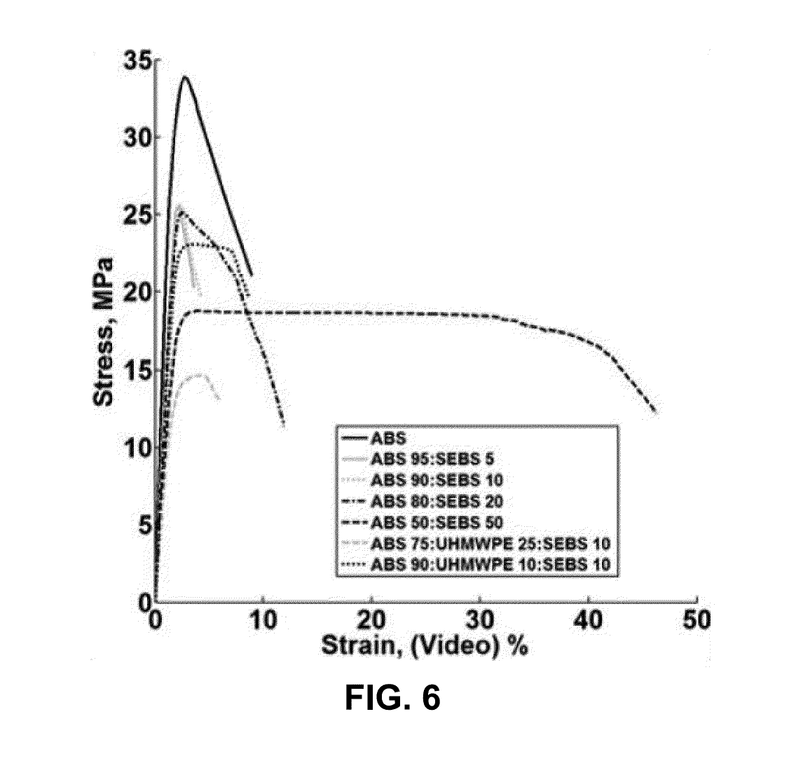

SEBS in an optimized ratio of 50/50 by weight percent blend of ABS/SEBS is used to generate toughened, rubberized ABS compatible with ME3DP platforms as depicted in the graph of FIG. 6. Note the difference in mechanical properties as compared with the base ABS resin. Most notable is the drastic increase in toughness for the 50% by weight SEBS blend.

Certain aspects are directed to a 3D-printable monofilament compatible with material extrusion 3D printers at a maximum of (or less than) 50% by weight SEBS. However, blends with ratios varying from the approximately 50% by weight SEBS are also contemplated as potentially adaptable for use in ME3DP.

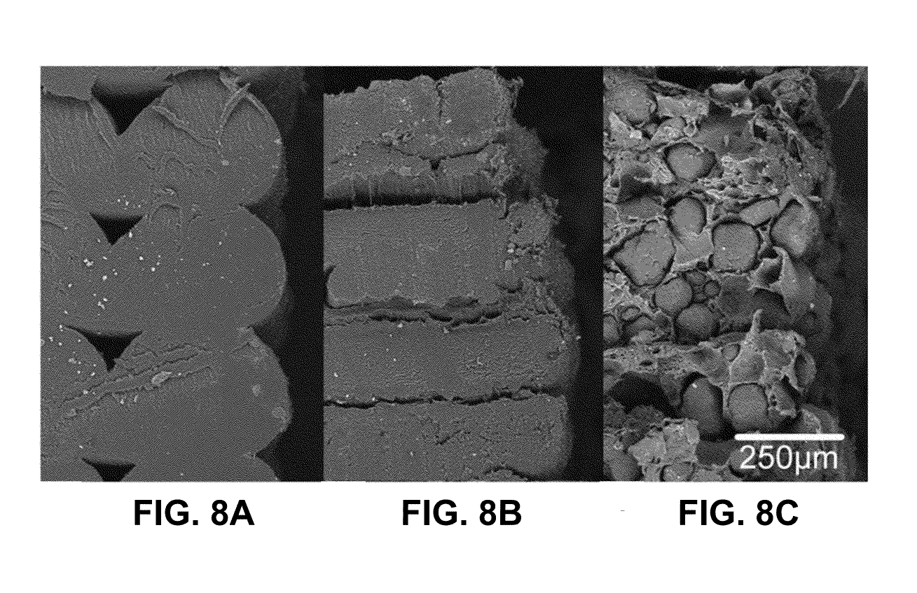

There are rheological differences in the 50/50 blend and there is a blending between rasters in the 3D printed part that leads to a smoother surface finish (FIG. 8). The blending of polymer matrix composites where the matrix material is a blend described herein produce a blend(s) having a lower propensity to manifest gas voids. Thus, while an approximately 50% blend is described, other percentages and ratios are contemplated and examples describing a 50/50 blend should in no way limit the scope of this disclosure.

Certain embodiments are directed to blends of acrylonitrile butadiene styrene (ABS) with styrene ethylene butadiene styrene (SEBS). In certain aspects the blends further comprise an ultrahigh molecular weight polyethylene (UHMWPE). The blends are compatible with current 3D printing platforms. In certain aspects compositions described herein can provide for production of a smooth surface finish of 3D printed inclined panes as well as providing decreased mechanical anisotropy to a printed article.

For example, one type of UHMWPE known as TIVAR® 1000 is an engineered polymers with a unique combination of wear and corrosion resistance, low friction surface and impact strength. TIVAR® 1000 is resistant to chemical attack and moisture absorption, and retains key physical properties to −30° C. It also meets FDA, USDA and 3-A Dairy guidelines for food processing and handling. The properties of TIVAR® 1000 may be further modified using methods known in the art, to create UV stabilized and anti-static blends. Custom colors compounded with FDA/USDA approved pigments, which meet FDA and USDA guidelines for food processing and handling may also be added to such blends to expand uses in the food, agricultural and pharmaceutical industries. Thus, the exemplary use of ABS, SEBS and UHMWPE should not be used to limit the scope of this disclosure.

However, other printable polymer blends, such as commercially available amorphous polymer blends such as PCABS (polycarbonate and ABS) and Ultem 9085 (polycarbonate and polyetherimide), which are both marketed by Stratasys, may also be used in the novel blends and are contemplated to be within the scope of this disclosure.

The present disclosure teaches novel ABS-based polymeric blends which are compatible with ME3DP, yet have physical properties that are different from pure ABS. Further novelty is derived from the use of the styrene ethylene butadiene styrene (SEBS) copolymer as both a blend with ABS and a compatibilizer agent in the blending of ABS with UHMWPE-a material that is semicrystalline and neither extrudable (without specialized equipment) nor compatible with ME3DP platforms. The use of SEBS as a compatibilizer for blends of polystyrene (PS) and high density polyethylene (HDPE) has been demonstrated in the art and the present disclosure utilizes the copolymer block to blend the similar materials ABS and UHMWPE.

SEBS has also been widely used as a “rubber toughening” agent for several polymer systems including nylon and polyethylene terephthalate (PET). Thus, use of SEBS achieved a toughened, rubberized ABS which was compatible with ME3DP platforms.

The polymer blending process has several advantages over synthesizing new printable polymers: i) by using known, printable materials as a base, the new blended materials are compatible with ME3DP platforms; and ii) polymer blending can be done away from large scale production facilities using small-batch polymer extruders, providing an expanding area for the development of new materials that meets the customer demand for personal 3D printing.

The present disclosure focuses broadly on altering the physical properties of printable base polymers (in this case ABS) for use in 3D printing through the addition of UHMWPE and the thermoplastic elastomer SEBS. Utilizing and optimizing these three polymeric materials can create unique combinations of properties, based on the individual constituents.

For example, ABS is based on three monomers (acrylonitrile, butadiene, and styrene). Of particular interest are the acrylonitrile and butadiene groups, the former is responsible for forming polar bonding between the chains (producing a stronger material) and the latter provides better mechanical resilience. Likewise, UHMWPE offers high toughness, wear and abrasion resistance, and impact strength. However, because UHMWPE is not compatible with most extrusion equipment and therefore, must be blended with other polymers for 3D printing, it lacks the melt flow capability required for printing, even above the melting temperature.

In comparison, polymeric elastomers such as SEBS have properties including low melt viscosity, low process temperature, and low distortion during extrusion. Also, SEBS has demonstrated high impact strength and high elongation at break.

Based on the properties of the components, blends are taught with properties suitable for a wide variety of uses in 3D printing. For example, a blended system of SEBS and ABS increases the elastomeric properties and toughness of ABS. Also, by incorporating a combination of SEBS and UHMWPE to ABS, the benefits of UHMWPE (toughness) supplement the properties of ABS and SEBS (printability and relatively low process temperature). To this end, two blend types were fabricated (ABS:SEBS and ABS:SEBS:UHMWPE) to take advantage of these properties and enhance the properties of one of the most common 3D printing materials, ABS.

Acrylonitrile butadiene styrene (ABS) (chemical formula (C₈H₈)x(C₄H₆)y(C₃H₃N)z) is a common thermoplastic polymer. Its glass transition temperature is approximately 105° C. (221° F.). ABS is amorphous and therefore has no true melting point. ABS is a terpolymer made by polymerizing styrene and acrylonitrile in the presence of polybutadiene. The proportions can vary from 15 to 35% acrylonitrile, 5 to 30% butadiene and 40 to 60% styrene. The result is a long chain of polybutadiene criss-crossed with shorter chains of polystyrene-co-acrylonitrile. The nitrile groups from neighboring chains, being polar, attract each other and bind the chains together, making ABS stronger than pure polystyrene. The polybutadiene, a rubbery substance, provides resilience even at low temperatures. For the majority of applications, ABS can be used between −20 and 80° C. (−4 and 176° F.) as its mechanical properties vary with temperature. In certain aspects compositions or blends described herein can comprise ABS in a weight percent of at least, at most, or about 90, 85, 80, 75, 70, or 65 weight percent.

Styrene-ethylene-butadiene-styrene (SEBS) is commercially available from Shell Chemical Company under the trademark KRATON G™. Styrene-ethylene-butadiene-styrene block copolymers (SEBS) can be composed of 10 to 70% by weight of polystyrene blocks and 30 to 90% by weight of ethylene-butadiene blocks. In certain aspects compositions or blends described herein can comprise SEBS in a weight percent of at least, at most, or about 20, 25, 30, 35, 40, 45, or 50% weight percent.

In certain aspects UHMWPE is a linear polyethylene with less than one side chain per 5,000 carbon atoms, or less than one side chain per 10,000 carbon atoms, or less than one side chain per 15,000 carbon atoms, or less than one side chain per 20,000 carbon atoms, wherein the side chain preferably contains at most 10 carbon atoms. In certain aspects compositions or blends described herein can comprise UHMWPE in a weight percent of at least, at most, or about 20, 25, 30, 35, 40, 45, or 50% weight percent. In certain aspects UHMWPE is present in a blend or composition at a ratio of at least or about 25:75 weight percent UHMWPE:ABS

Certain aspects are directed to binary and ternary polymeric blends for ME3DP. In certain aspects a composition, e.g., blend, is produced by combining components using a twin screw compounding process. In certain aspects the blend will be about 80, 70, 60, 50 parts by weight ABS to 20, 30, 40, 50 SEBS parts by weight, including all values and ranges there between. In a further aspect the blend is 80:20, 70:30, 60:40, or 50:50 ABS:SEBS by weight.

In other aspects the blend comprises ABS, SEBS, and UHMWPE. In certain aspects the blend will comprise a mass ratio of ABS:UHMWPE:SEBS of about 90, 85, 80, 75 weight percent ABS, including all values and ranges there between; about 25, 20, 15, 10 weight percent UHMWPE, including all values and ranges there between; and about 5, 10, 15 weight percent SEBS, including all values and ranges there between. In certain aspect the mass ratio of ABS:UHMWPE:SEBS is about 90:10:10, 85:15:10, 80:20:10 or 75:25:10, including all values and ranges there between.

Other embodiments are directed to a process of blending UHMWPE with ABS using SEBS as a compatibilizer. A compatibilizer as used herein is a substance used to stabilize blends of immiscible polymers. A compatibilizer is often added to blends of immiscible polymers to reduce the interfacial tension between them. Compatibilizers have also been employed to improve wet out or coupling of polymers and additives or fillers in composite materials. In both cases, the addition of compatibilizer can result in improved processing and mechanical properties of the resulting blend or composite. Functionalized copolymers are a class of materials applied as compatibilizers. In general, functionalized copolymers are polymers that have some form of reactive functional groups incorporated throughout the polymer backbone.

Mechanical testing and fractography were used to characterize the different physical properties of the blend(s) described herein. Though the blends described herein possess different physical properties, compatibility with ME3DP platforms is maintained. Also, a decrease in surface roughness of a standard test piece was observed for certain blends as compared with ABS.

Different blends of ABS were made with varying weight percentages of SEBS: 5, 10, 20, and 50% (in terms of ABS:SEBS ratio 95:5, 90:10, 80:20, and 50:50) and compared with baseline samples created from ABS.

### EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

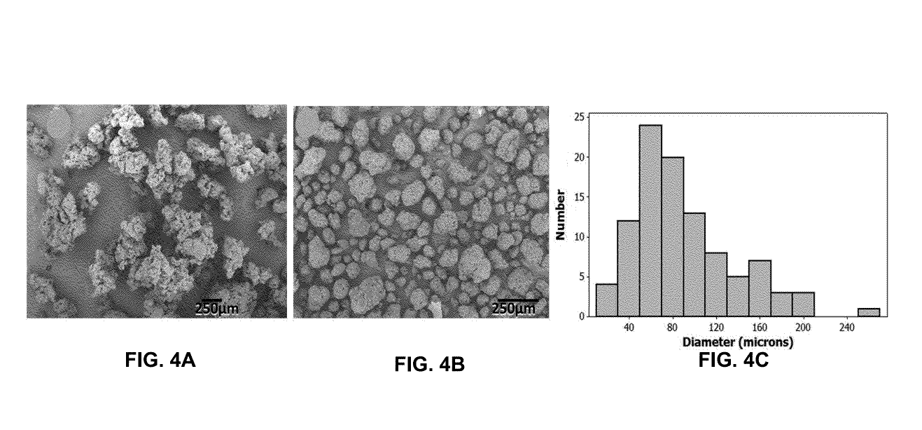

ABS/UHMWPE/SEBS blends—Blends of UHMWPE with ABS using SEBS as a compatibilizer were made using GUR® 1020 UHMWPE (Celeanese, Irving, Tex.) blended with the same ABS and SEBS materials mentioned above. The UHMWPE was in powder form with a size distribution as determined by plotting data on the graph in FIG. 4C. The size distribution of the UHMWPE polymer was measured to be 92.6±45 μm. The ternary blends tested in this study were based on mass ratios of ABS:UHMWPE:SEBS of 90:10:10 and 75:25:10.

A printable monofilament was created when the weight percent of UHMWPE was greater than 25% compared with the ABS base (greater than an ABS:UHMWPE ratio of 75:25). The mixtures were fed to the same twin screw extruder/compounder; however, the operating parameters used for these blends were at a temperature of 195° C., under a pressure of 72 bar, and a screw rate of 40 rpm. In contrast to both blend systems, the pure ABS filament was created using extrusion parameters at a temperature of 175° C., under a pressure of 54 bar, and a screw rate of 50 rpm. All extrusion parameters for the various blends are shown in Table I, and it should be noted that the difference in physical properties necessitated different extrusion parameters which were determined empirically.

TABLE I
Extrusion parameters for the blended materials.

| | | | | | | | | | |
|---|---|---|---|---|---|---|---|---|---|
| | | | | | | | | Pressure | |
| | | T | T | | T | RPM | RPM feed | (P) main | |
| | T zone | zone | zone | T zone | zone | main | screw (% | screws | Load |
| Material | 1 (° C.) | 2 (° C.) | 3 (° C.) | 4 (° C.) | 5 (° C.) | screw | main) | (bar) | (%) |

ABS:SEBS

| | | | | | | | | | |
|---|---|---|---|---|---|---|---|---|---|
| 1:0 | 170 | 182 | 187 | 187 | 187 | 35 | 6 | 100 | 72 |
| 95:5 | 170 | 182 | 187 | 187 | 187 | 35 | 6 | 100 | 72 |
| 90:10 | 170 | 182 | 187 | 187 | 187 | 35 | 6 | 92 | 68 |
| 80:20 | 165 | 170 | 170 | 170 | 170 | 55 | 6 | 73 | 64 |
| 50:50 | 160 | 165 | 165 | 165 | 165 | 70 | 6 | 45 | 61 |

ABS:UHMWPE:SEBS

| | | | | | | | | | |
|---|---|---|---|---|---|---|---|---|---|
| 75:25:10 | 155 | 185 | 185 | 185 | 185 | 40 | 6 | 80 | 62 |
| 90:10:10 | 155 | 195 | 195 | 195 | 190 | 40 | 6 | 72 | 60 |

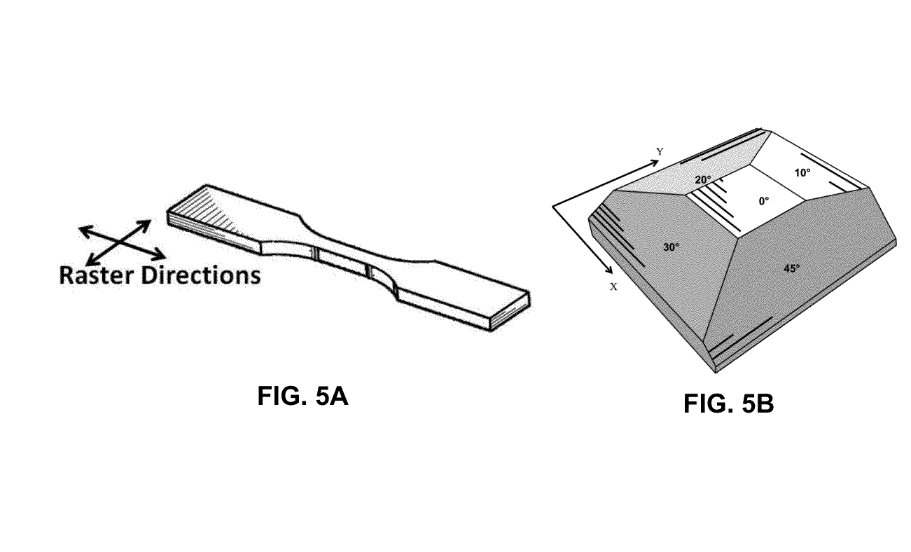

Materials testing and characterization—The blended materials underwent tensile testing following the ASTM Standard D638-10 using the Type V dimensions. To verify commercial printability, these samples were printed using a MakerBot Replicator material extrusion 3D printer. The print direction of the dog-bone structures was in the XYZ direction as depicted in FIG. 5A with a raster height of 0.4 mm and a raster width of 0.4 mm. The raster path was set to produce a maximum filling percentage. A slight modification was made to the MakerBot Replicator; the stock drive gear was replaced with a “hyena” gear as it was found this gear works better with the blended polymer filaments. Additionally, a modified nozzle with a diameter of 0.8 mm was used to print some of the blends as seen in Table II. Machine printing parameters used for each material are listed in Table II and, as was the case with the extrusion process, the 3D printing process demanded different properties based on the material type. The tensile test specimens were subjected to loading using an Instron® 5866 tensile tester, and the resulting stress, strain, and average Young's modulus were recorded.

TABLE II
MakerBot print parameters for all materials.

| | | | | | | | | | | |
|---|---|---|---|---|---|---|---|---|---|---|
| | | | | | Travel | | | G-code | Actual | |
| | Object | Layer | No. | Feed | feed | Print | Filament | nozzle | nozzle | |
| | infill | height | of | rate | rate | Temperature | Diameter | Diameter | Diameter | |
| Material | (%) | (mm) | shells | (mm's) | (mm's) | (° C.) | (mm) | (mm) | (mm) | Raft |

ABS:SEBS

| | | | | | | | | | | |
|---|---|---|---|---|---|---|---|---|---|---|
| 1:0 | 100 | 0.27 | 1 | 40 | 55 | 230 | 1.9 | 0.4 | 0.4 | No |
| 95:5 | 100 | 0.27 | 1 | 40 | 55 | 230 | 1.9 | 0.4 | 0.4 | No |
| 90:10 | 100 | 0.27 | 1 | 40 | 55 | 240 | 1.9 | 0.6 | 0.8 | No |
| 80:20 | 100 | 0.20 | 1 | 40 | 55 | 240 | 1.9 | 0.6 | 0.8 | No |
| 50:50 | 100 | 0.20 | 1 | 40 | 55 | 240 | 1.9 | 0.6 | 0.8 | No |

ABS:UHMWPE:SEBS

| | | | | | | | | | | |
|---|---|---|---|---|---|---|---|---|---|---|
| 75:25:10 | 100 | 0.20 | 1 | 40 | 55 | 230 | 1.9 | 0.6 | 0.8 | No |
| 90:10:10 | 100 | 0.20 | 1 | 40 | 55 | 230 | 1.9 | 0.6 | 0.8 | No |

Fracture surfaces of representative specimens from each sample pool were analyzed with a Hitachi TM-1000 scanning electron microscope (SEM) operating at a 15 kV accelerating potential and equipped with a backscatter electron (BSE) detector. SEM imaging allowed fracture surface morphology observations of the blended structures to identify common failure modes within these new material systems. As the goal of this paper was to demonstrate the development of new polymeric blends, a test to measure the printability of the material beyond the printing of mechanical testing specimens was developed. A test structure designed to test the ability to print an inclined plane was developed with surface angles at 10°, 15°, 30°, and 45° with respect to the normal surface of the XY plane as illustrated in FIG. 5B. The specific angles were chosen based on precedence set in the literature. Surface roughness measurements were taken using a Mitutoyo surface roughness tester and were also made on the flat top surface and bottom surface of the test piece (0° top and 0° bottom in the x and y direction).

Results with ABS/SEBS blends—The results of the mechanical testing data are shown in Table III below. As can be seen, blends that were 5% and 10% by weight SEBS (the 95:5 and 90:10 ABS:SEBS blends) do not exhibit an improvement in mechanical properties and suffered from a slight decrease in ultimate tensile strength (UTS) of 25.5±2.3 and 26.2±2.5 MPa for 5% and 10% SEBS as compared with UTS of 34.0±1.74 MPa for the baseline ABS samples. The blends with 20% and 50% by weight SEBS (the 80:20 and 50:50 ABS:SEBS blends) also displayed a lower UTS (18.0±0.03 MPa); however, there was a dramatic increase in the percentage of elongation at the breaking strength where the 20% SEBS blend 50% SEBS blend displayed elongation percentage values of 11.9±2.1% and 47.6±5.0% compared with 8.6±3.3% for the baseline ABS specimens. The increase in plastic deformation before fracture is indicative of an increase in toughness over the original ABS base resin. The stress—strain data for all blends are represented graphically in FIG. 6. Each stress—strain curve is a composite curve of every tested sample for a given blend. The data compiling to generate the curves was achieved by a process described in the study of Torrado et al. where a MatLab®-based program was used. By comparing the elongation percentage before failure, it is possible to observe the difference in toughness for the new polymeric blends as compared with the base ABS resin. It is important to note that though there were differences in the mechanical properties of the blends, the materials were still compatible with our ME3DP platform.

TABLE III
Mechanical testing data for all material tested in this study.

| | | |
|---|---|---|
| Material | UTS (MPa) | Elongation at break (%) |

ABS:SEBS

| | | |
|---|---|---|
| 1:0 | 34.0 ± 1.74 | 8.6 ± 3. 3 |
| 95:5 | 25.5 ± 2.3 | 3.6 ± 0.7 |
| 90:10 | 26.2 ± 2.5 | 4.0 ± 1.1 |
| 80:20 | 25. 2 ± 1.8 | 11.9 ± 2.1 |
| 50:50 | 18.0 ± 0.03 | 47.6 ± 5.0 |

ABS:UHMWPE:SEBS

| | | |
|---|---|---|
| 75:25:10 | 14.7 ± 0.7 | 5.7 ± 0.7 |
| 90:10:10 | 23.1 ± 0.8 | 8.4 ± 1.0 |

Sample size, n = 5

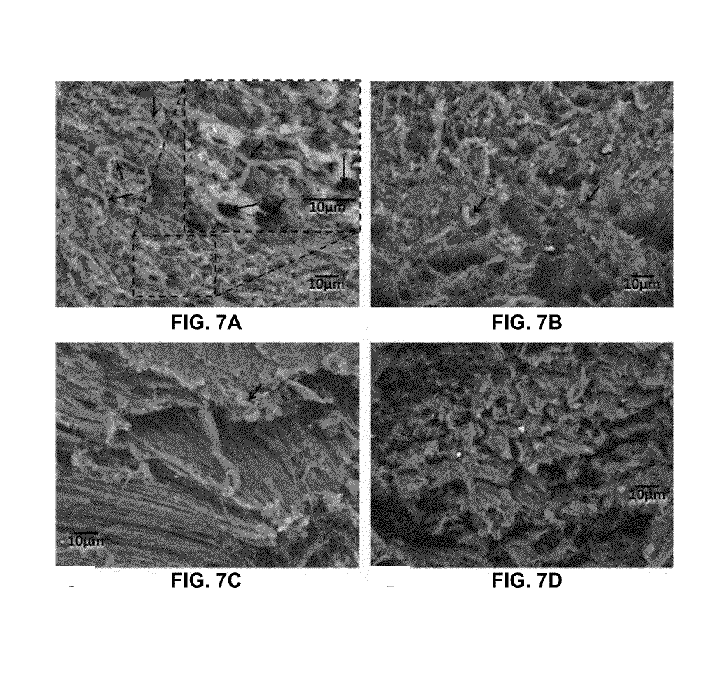

Scanning electron microanalysis of the fracture surfaces from representative specimens from each blend sample pool revealed different characteristics based on the weight percentage of SEBS in the blend. In general, the fracture surface of the tensile specimens is indicative of craze cracking which propagated normal to the direction of applied stress as has also been demonstrated in the literature. The prominent features of the fracture surface for the 5% and 10% by weight SEBS blends are the presence of fibrils (FIG. 7). The fracture surfaces of the tensile specimens are indicative of craze cracking, and all fracture surfaces prominently display fibrils, highlighted by black arrows in FIGS. 7A, 7B, and 7C.

These fibrils appear to have torn out of the surrounding matrix, and they decrease in number as the concentration of SEBS increases. In terms of miscibility, this may indicate that ABS is miscible in SEBS because an increase in SEBS concentration corresponds to a decrease in fibrils present. Also, an increase in SEBS concentration causes a shift in the mechanical behavior of the tensile specimens toward a material that is more elastic than ABS alone.

The ABS blends with a concentration of 20% and 50% SEBS were qualitatively different in terms of surface smoothness than the samples printed from pure ABS. These two SEBS blends were subjected to surface roughness testing utilizing the printed test piece discussed above in FIG. 5B and the results are shown in Table IV. As can be seen in the table, the 50% SEBS blend led to the printing of smoother 45° and 30° degree surfaces as compared with the sample printed from ABS. The reason for the improvement in surface roughness for inclined planes is due to the unique characteristics in the way the material is deposited during the printing process that is influenced by the rheological differences between the material systems. As is seen in the SEM images of cross sections from samples printed from selected blends in this study (FIG. 8), the filament shape is still discernable for the sample printed from ABS while the 50:50 ABS :SEBS blend deposits differently. The difference in deposition morphology allows for the creation of smoother inclined planes. The other surfaces of the ABS test piece were comparable for the blends tested.

The ternary blend has the propensity to deposit in a more spread out fashion than the other blends to the point that it is difficult or impossible to discern the deposition layers as can be seen when one compares the print rasters near the edges of specimens for ABS [FIG. 8A], the 50% SEBS blend [FIG. 8B], and the 75:25:10 ternary blend [FIG. 8C]. From the images, it can be seen that in all cases, the roughness in the x direction was less than that in the y direction due to the fact that in the y direction the test probe traveled against the print raster direction while measurements in the x direction were parallel with the print raster direction. Once again, though the material displayed different mechanical properties as compared with ABS, the inventors were still able to use it as the feedstock on their ME3DP platform. Note that in FIG. 8C the 75:25:10 ABS:UHMWPE:SEBS ternary blend has a propensity to blend raster layers leading to an overall smoother surface finish for inclined planes.

TABLE IV
Surface roughness measurements (Ra in μm) for selected materials.
Surface

| | | | | | | | | |
|---|---|---|---|---|---|---|---|---|
| Material | 45° | 30° | 15° | 10° | 0° top x | 0° top y | 0° bottom x | 0° bottom y |

ABS:SEBS

| | | | | | | | | |
|---|---|---|---|---|---|---|---|---|
| 1:0 | 47.2 ± 8.6 | 49.8 ± 5.4 | 62.9 ± 3.6 | 50.7 ± 5.8 | 9.7 ± 2.7 | 33.9 ± 4.3 | 1.06 ± 0.2 | 5.56 ± 5.8 |
| 80:20 | 44.8 ± 2.4 | 49.0 ± 1.7 | 59.4 ± 2.6 | 47.6 ± 12.4 | 13.0 ± 4.0 | 17.1 ± 7.3 | 1.8 ± 1.3 | 1.8 ± 0.7 |
| 50:50 | 35.9 ± 0.7 | 38.8 ± 4.7 | 64.5 ± 1.4 | 52.2 ± 13.3 | 11.3 ± 3.0 | 16.9 ± 5.9 | 1.5 ± 0.5 | 2.8 ± 1.8 |

ABS:UHMWPE:SEBS

| | | | | | | | | |
|---|---|---|---|---|---|---|---|---|
| 75:25:10 | 29.7 ± 6.0 | 47.0 ± 7.6 | 40.9 ± 10.1 | 36.0 ± 11.3 | 18.5 ± 6.7 | 34.0 ± 4.1 | 20.4 ± 5.4 | 23.8 ± 6.8 |
| 90:10:10 | 47.9 ± 9.9 | 40.2 ± 5.2 | 44.5 ± 2.9 | 29.9 ± 4.7 | 13.3 ± 2.9 | 28.6 ± 4.3 | 3.8 ± 0.9 | 3.9 ± 1.5 |

ABS/UHMWPE/SEBS blends—Mechanical testing data for the two ternary blends tested here are listed in Table III. In both blended cases, the material's UTS was weaker than ABS. The average UTS for the ABS:UHMWPE:SEBS (75:25:10) blend was 14.7±0.7 MPa while the ABS:UHMWPE:SEBS (90:10:10) blend produced samples with an average UTS of 23.1±0.8 MPa, as compared with 34.0±1.74 MPa for the baseline ABS samples.

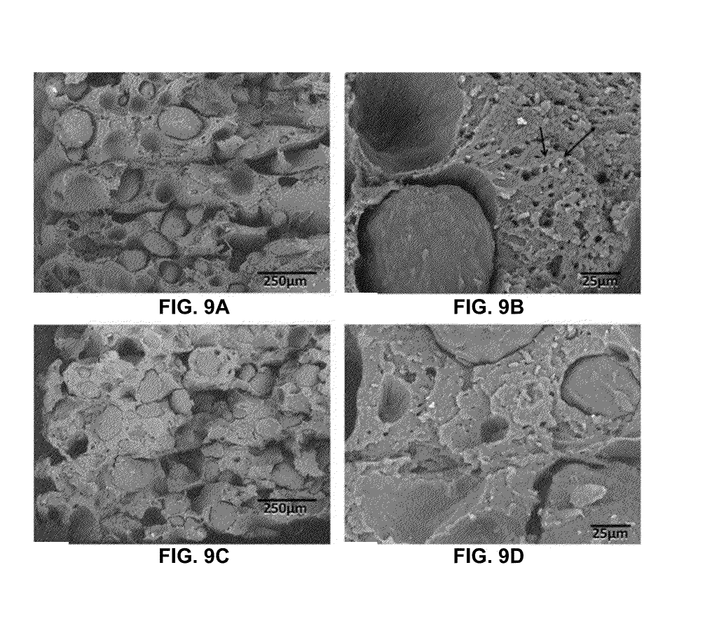

The electron micrographs of the fracture surfaces of representative samples for the two ternary blends (ABS:UHMWPE:SEBS—75:25:10 and 90:10:10) examined in this study are depicted in FIG. 9. Large globules are of consistent in size with undissolved UHMWPE. At higher magnifications in FIGS. 9B and 9D the undissolved UHMWPE appear to be pulled out of the composite matrix and free-to-move after testing, in addition to have undergone melting.

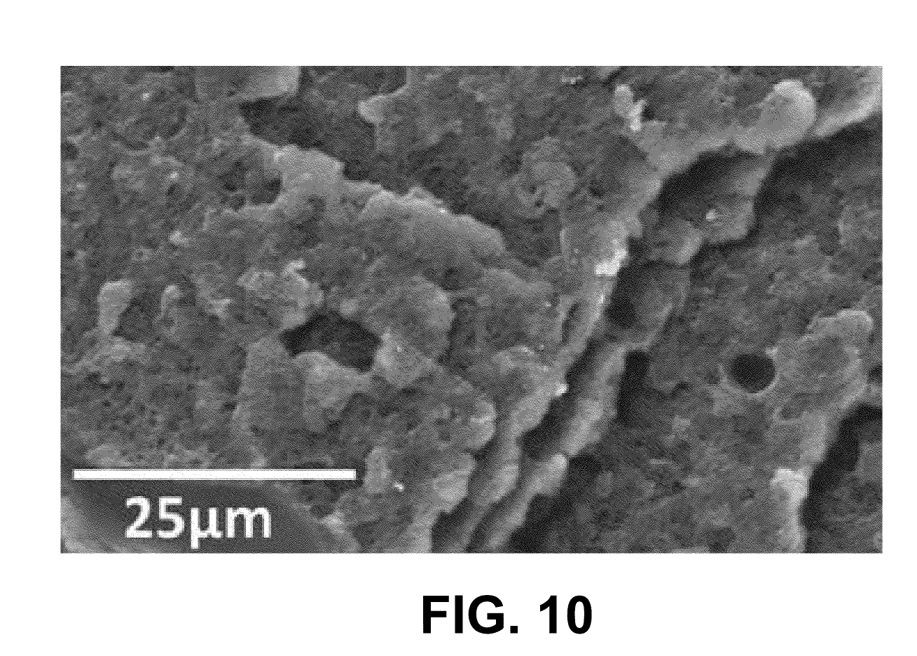

Analysis of the micrographs confirmed prominent globules of the material in both ternary blends. Comparing the size of the globules to the size distribution of the UHMWPE powder confirms that the globules are most-likely undissolved UHMWPE particles. The surface features of the globules are much smoother than the original powder and are most likely due to particle melt during the extrusion process as the process was above the melting temperature (Tₘ 130° C.) of UHMWPE. The particles also appear to pull out of the matrix as there are several cavities and free-to-move particles on the fracture surface. The fracture morphology of the matrix material is more brittle than even the comparable mixtures of ABS and SEBS meaning that it is possible that some of the UHMWPE did dissolve into the ABS matrix or that the SEBS mixed with the UHMWPE as the fracture surface of the matrix resembles the fracture surface of pure ABS (FIG. 10). Also present in the fracture surface of both ternary blends are fibrils and voids where the fibrils pulled out [highlighted by black arrows in FIG. 9B]. The mechanics of the fibril tear out is more prominent in these figures than in the ABS:SEBS blend images and may point to a threshold of miscibility between SEBS and ABS.

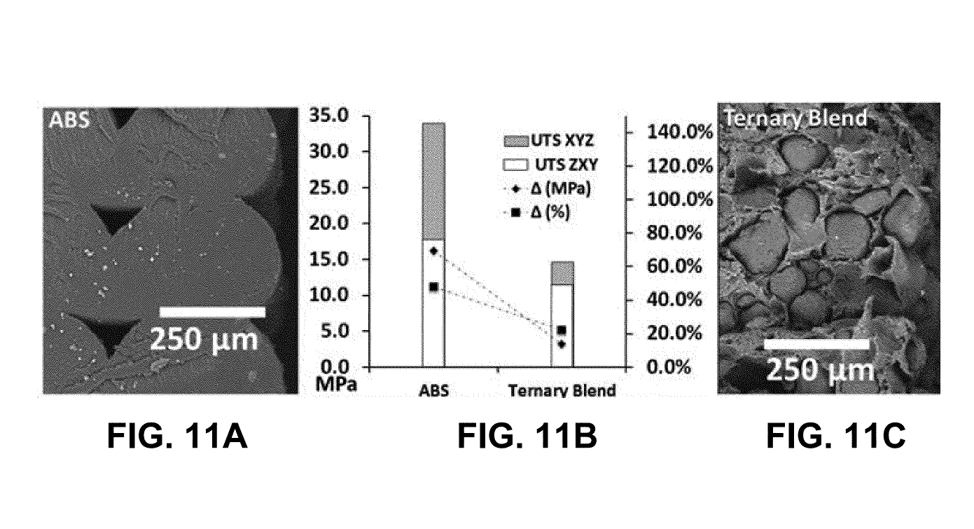

Surface roughness measurements (Table IV) show that for inclined surfaces, the 75:25:10 ternary blend produced the smoothest surfaces of all materials tested in this study whereas the flat surfaces were among the roughest tested here. As was the case with the 50:50 ABS:SEBS blend, one reason for the smoother inclined planes may be the rheological differences for this blend as compared with the others. As depicted in FIG. 11A)/ABS and FIG. 11C/ternary blend, the rheological differences of the ternary blend as compared to ABS obscure the print rasters leading to a decrease in build orientation-caused mechanical property anisotropy.

FIG. 11B depicts the decrease in ultimate tensile strength anisotropy between ABS and the 75:25:10 ABS:UHMWPE:SEBS ternary blend, for specimens 3D printed in the XYZ and ZXY orientations.

The disclosure herein demonstrates the development of polymeric blends for material extrusion 3D printing platforms through characterization of mechanical properties, phase morphology, and 3D printer compatibility of novel copolymer blend systems (ABS:SEBS and ABS:UHMWPE:SEBS), each having different physical and chemical characteristics. Toward this goal, the 3D printability of novel binary and ternary polymer blends of varying constituent concentrations was determined by printing standard tensile test specimens and a roughness testing piece with multi-angled inclined planes using a commercially available MakerBot Replicator. In terms of roughness, the 50:50 ABS:SEBS provided smoother flat surfaces and the 75:25:10 ABS: UHMWPE:SEBS blend provided the smoothest sloped surfaces due to the rheological differences as compared with ABS and the other blends in this study. Mechanical testing was also performed on all printable copolymer blends. Through this testing, the inventors observed that blending any amount of SEBS and UHMWPE into an ABS matrix lowered the UTS of printed tensile specimens.

It was also observed when SEBS copolymer blends were loaded greater than 20%, the elongation percentage values (amount of plastic deformation endured by the material prior to failure) increased where tensile test samples printed from the 50:50 ABS:SEBS blend displayed elongation percentage values approaching 50% which is indicative of an increase in toughness of the material.

Characterization of the ABS:UHMWPE:SEBS and ABS:SEBS blends via SEM microanalysis revealed an insolubility of UHMWPE within the ABS matrix as for the ternary blends as well as a solubility threshold between ABS and SEBS for the binary blends. In all cases, ABS blends with altered physical properties were created and demonstrated to be compatible with a desktop grade material extrusion 3D printer. In the case of the binary ABS:SEBS blend, manipulation of the percentage of elongation at break was achieved by changing the ABS:SEBS ratio.

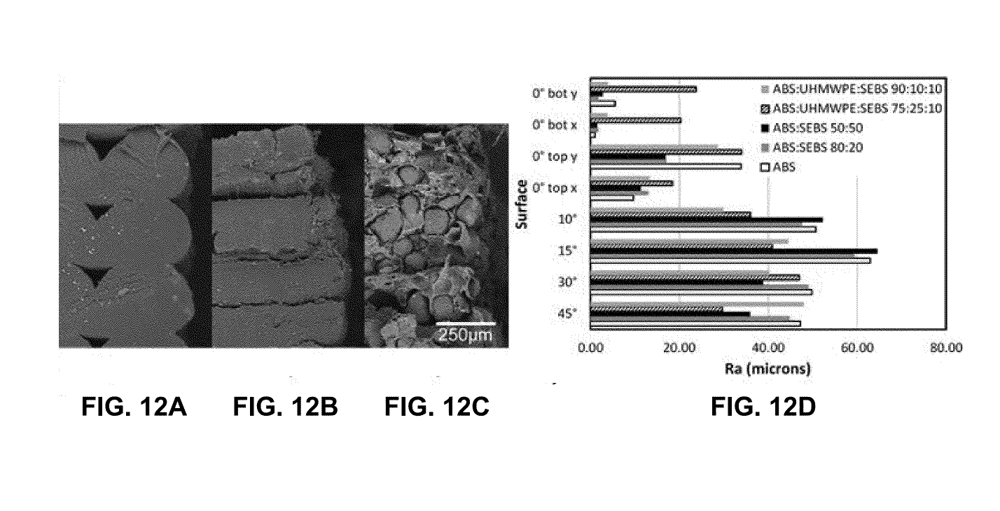

The SEM images of cross sections in FIG. 12A ABS, FIG. 12B ABS:SEBS 50:50 blend and FIG. 12C ABS:UHMWPE:SEBS 75:25:10 indicate the differences in print rasters. FIG. 12D which provides corresponding surface roughness data from a test piece, confirms the ability of these novel blends to print smoother inclined planes.

While the addition of UHMWPE was detrimental to the ultimate tensile strength (UTS), the result was a 3D printable material capable of printing smoother inclined planes than the ABS base material alone. The examples herein demonstrate the ability to create 3D printer compatible materials with tailorable physical properties that can be customized for a given application.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure may include descriptions of various benefits and advantages that may be provided by various embodiments. One, some, all, or different benefits or advantages may be provided by different embodiments. In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

1. A polymer blend composition for material extrusion 3D printing comprising: acrylonitrile butadiene styrene (ABS) and styrene ethylene butadiene styrene (SEBS).

2. The composition of claim 1, wherein the blend comprises a ratio of ABS:SEBS between about 80:20 and about 50:50 by weight.

3. The composition of claim 1, wherein the blend comprises a ratio of ABS:SEBS of about 50:50 by weight.

4. The composition of claim 1, wherein the composition is configured as a printable monofilament.

5. A composition for material extrusion 3D printing comprising a blend of acrylonitrile butadiene styrene (ABS), styrene ethylene butadiene styrene (SEBS), and ultrahigh molecular weight polyethylene (UHMWPE).

6. The composition of claim 5, wherein the blend comprises a ratio of ABS:UHMWPE:SEBS between 75:25:10 and 90:10:10 by mass.

7. A method of blending acrylonitrile butadiene styrene with ultrahigh molecular weight polyethylene comprising:
(a) mixing acrylonitrile butadiene styrene (ABS) with styrene ethylene butadiene styrene (SEBS); and
(b) adding ultrahigh molecular weight polyethylene (UHMWPE) to the mixture of step (a).

8. The method of claim 7, wherein the ratio of the ABS:SEBS in the mixing step is about 50:50 by weight.

9. The method of claim 7, wherein the resulting blend after the mixing and adding steps of ABS:UHMWPE:SEBS is between 75:25:10 and 90:10:10 by mass.

10. The method of claim 7, comprising the additional step of using the resulting ABS:UHMWPE:SEBS blend as a polymer for material extrusion 3D printing.

11. The blend produced by the method of claim 7.

12. The blend produced by the method of claim 9.
